(19) United States
(12) Patent Application Publication
(10) Pub. No.: US 2025/0306730 A1
(43) Pub. Date: Oct. 2, 2025

(54) CONTEXT-AWARE MANAGEMENT OF TIMER FUNCTION NOTIFICATIONS

(71) Applicant: The Toronto-Dominion Bank, Toronto (CA)

(72) Inventors: Jung Sook LIM, Markham (CA); Emily Anne LOWTHER, Elmira (CA); Lemin WU, Markham (CA); John Jong-Suk LEE, Toronto (CA)

(73) Assignee: The Toronto-Dominion Bank, Toronto (CA)

(21) Appl. No.: 18/618,546

(22) Filed: Mar. 27, 2024

(51) Int. Cl. G06F 3/0482; G06F 3/04886

(52) U.S. Cl. CPC G06F 3/0482; G06F 3/04886

(57) ABSTRACT

A computer-implemented method is disclosed. The method includes: determining that a time-limited action is active; detecting a trigger condition representing a change in interaction focus; in response to detecting the trigger condition: generating a notification indicating remaining time associated with the time-limited action; providing the notification to an output interface associated with a computing device.

### TECHNICAL FIELD

The present application relates to user interface design and assistive technology and, more particularly, to methods for managing notifications that are provided to users of assistive technologies.

### BACKGROUND

Timer functions may be implemented on user interfaces to indicate the time-limited nature of various actions or tasks. By way of example, a countdown timer may be displayed on a cart checkout page to encourage customers to complete purchase of the products in their cart within a specific time period (i.e., before the timer expires). When a cart checkout page is launched on a customer's device, the countdown timer indicates the currently remaining amount of time for the customer to complete a checkout form and submit their order. The “remaining time” information for the countdown timer may be presented to the customer in the form of notifications on the customer's device.

### BRIEF DESCRIPTION OF THE DRAWINGS

Embodiments are described in detail below, with reference to the following drawings:

FIG. 1 is a schematic diagram illustrating an operating environment of an example embodiment;

FIG. 2A is high-level schematic diagram of a computing device;

FIG. 2B shows a simplified organization of software components stored in a memory of the computing device of FIG. 2A;

FIG. 3 shows, in flowchart form, an example method of managing notifications associated with a timer function for a user interface;

FIG. 4 shows, in flowchart form, an example method of managing scheduled notifications associated with a timer function for a user interface;

FIG. 5 shows, in flowchart form, an example method of providing timer function notifications via an assistive technology process; and

FIG. 6 shows, in flowchart form, an example method of managing notifications associated with a timer function for a user interface using a predictive model for analyzing patterns in interaction focus.

Like reference numerals are used in the drawings to denote like elements and features.

### DETAILED DESCRIPTION OF VARIOUS EMBODIMENTS

In an aspect, the present disclosure describes a computing system. The computing system includes a processor and a memory coupled to the processor. The memory stores computer-executable instructions that, when executed, may configure the processor to: determine that a time-limited action is active; detect a trigger condition representing a change in interaction focus; in response to detecting the trigger condition: generate a notification indicating remaining time associated with the time-limited action; provide the notification to an output interface associated with a computing device.

In some implementations, determining that the time-limited action is active may include determining that a user is currently interacting with a user interface and the trigger condition may be detected based on interactions with the user interface.

In some implementations, detecting the trigger condition may include determining that the user has: moved a cursor from one text field to another text field; selected or de-selected a checkbox; selected an item from a drop-down menu; scrolled past a user interface (UI) element such that the UI element moves out of view; or paused for greater than a threshold length of time.

In some implementations, the instructions, when executed, may further configure the processor to obtain a first scheduled notification of remaining time associated with the time-limited action and generating the notification may include modifying the first scheduled notification to indicate the remaining time at a time of detecting the trigger condition.

In some implementations, the first scheduled notification may be a notification that is scheduled to be presented via the user interface at regular intervals starting from a time when the user first initiated the time-limited action.

In some implementations, the instructions, when executed, may further configure the processor to determine that a predetermined amount of time has elapsed since start of the time-limited action and the notification may be generated in response to determining that the predetermined amount of time has elapsed and detecting the trigger condition.

In some implementations, the notification may comprise an audible reminder of the remaining time and providing the notification may include inserting the notification in speech output of a screen reader program at a point corresponding to a time of detecting the trigger condition.

In some implementations, the instructions, when executed, may further configure the processor to: determine, based on a predictive model, that the interaction focus will not change prior to expiry of a time limit associated with the time-limited action; and in response to determining that the interaction focus will not change, force an interrupt of a timer for the time-limited action.

In some implementations, the instructions, when executed, may further configure the processor to, in response to determining that the interaction focus will not change, pause a count by the timer or add additional time to the timer.

In some implementations, the instructions, when executed, may further configure the processor to modify a schedule of notifications for the time-limited action responsive to providing the notification to the output interface.

In another aspect, the present disclosure describes a computer-implemented method. The method includes: determining that a time-limited action is active; detecting a trigger condition representing a change in interaction focus; in response to detecting the trigger condition: generating a notification indicating remaining time associated with the time-limited action; providing the notification to an output interface of a computing device.

In yet another aspect, a non-transitory computer readable storage medium is disclosed. The computer readable storage medium contains instructions thereon which, when executed by a processor, may configure the processor to: determine that a time-limited action is active; detect a trigger condition representing a change in interaction focus; in response to detecting the trigger condition: generate a notification indicating remaining time associated with the time-limited action; provide the notification to an output interface of a computing device.

Other aspects and features of the present application will be understood by those of ordinary skill in the art from a review of the following description of examples in conjunction with the accompanying figures. Example embodiments of the present application are not limited to any particular operating system, system architecture, mobile device architecture, server architecture, or computer programming language.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

Certain user actions for interacting with a user interface may be time-limited. A time-limited user action is an action which must be performed within a fixed amount of time, or during a specific time window (i.e., between defined start and end times). When a time-limited user action is initiated, a countdown timer may be started. The countdown timer is initialized to a specified time duration and counts down to zero. Throughout the countdown, the timer indicates the currently remaining amount of time for completing the action.

Time limits may be imposed on user actions for various reasons. In some scenarios, a time limit may facilitate effective management of access to a finite quantity of resources. For example, a product purchase action on a merchant website may be time-limited to ensure that customers complete their transaction without delay and that other prospective customers can promptly access as-yet unsold inventory of the product. When a product item is added to a cart, a timer associated with the cart can indicate the remaining time for the customer to complete the purchase of the product item. The selected quantity of the product item is then held or “reserved” for the customer during the countdown period. Once the timer expires, any unpurchased units of the product item in the cart are “returned” to the inventory of the product; the customer would have to start over if they wish to purchase additional units of the product item.

A time limit may also serve as a security mechanism. A secured system may require users to input certain information (e.g., passwords, secret answers, etc.) for authentication. In particular, users may be prompted to input complete authentication information within a specific time window during a login process. A time limit on user input of authentication details may support improved security for the system by ensuring that only authorized users are authenticated to the system (for example, by restricting the time window for login attempts) and/or by limiting the potential for unauthorized parties to gain access to the user interface and any information inputted therein.

Notifying a user of time limits and/or remaining time for a particular action may enable the user to better manage their progress towards completing the action. The notifications may be visual (e.g., a timer UI element) or auditory (e.g., voice alerts). In some implementations, a timer notification mechanism may define a fixed schedule of notifications (“reminder notifications”) for reminding the user of the currently remaining amount of time for completing the action. The reminder notifications may be presented while the user is actively performing the action. For example, a defined number of reminder notifications may be scheduled to be presented at regular intervals throughout a countdown period that begins when the user initiates the action.

While reminder notifications for a time-limited user action are easy to schedule, they may ultimately be distracting to the user receiving the notifications. In particular, scheduled reminder notifications for an action may lead to reduced cognitive focus for the user when they are performing the action and require a contextual realignment by the user each time a scheduled notification is presented to the user. The disruptive effect of scheduled reminder notifications may be particularly detrimental for users with disabilities. For example, visually impaired users rely primarily on use of screen readers when interacting with user interfaces. The adverse cognitive effect of auditory notifications that are scheduled for delivery without regard to device context and/or usage are likely to be amplified for users of screen readers. It is desired to provide a timer notification mechanism for user interfaces that effectively implements a reminder function while minimizing the disruptive effect of the notifications.

The present application discloses a system and methods for managing timer function notifications. Given a time-limited user action that is performed via a user interface, a fixed schedule of timer notifications for the user action may be defined. For example, reminder notifications indicating the currently remaining amount of time for completing an action may be scheduled for delivery to the user at regular intervals starting from the time when the user initiates the action. At a scheduled time of a first timer notification, the system determines whether a user is currently interacting with at least one user interface element. In particular, the system may determine, based on monitoring the user's interaction with the user interface, whether a particular UI element is in focus. If the user is determined to not be interacting with any UI element, the first timer notification (e.g., a visual, audio, or haptic alert) may be presented to the user as-is and as-scheduled.

If, on the other hand, the user is determined to be interacting with at least one UI element (e.g., a text input field), the system monitors for defined trigger conditions associated with the user interface. The trigger conditions relate to determining a focus of attention by the user when interacting with UI elements. Specifically, each trigger condition may indicate a change in user focus, which may be determined based on detected user engagement with one or more UI elements. An interaction that represents a change in user focus may signal that the user has completed a particular task-a notification presented at such time may minimize the potential for distracting or interrupting the user and thereby maximize effectiveness of the notification. A trigger condition may be detected, for example, when the user: changes the focus from one UI element to another; moves a cursor from one text field to another text field; selects or de-selects a checkbox; selects an item from a drop-down menu; scrolls past a UI element, e.g., such that the UI element moves out of view; or has paused for greater than a threshold length of time.

Upon detecting a defined trigger condition, the system presents, to the user, a suitable notification of remaining time for the user action. The remaining time is calculated relative to the time of detecting the trigger condition. In some implementations, a new notification indicating the calculated remaining time may be generated by the system and provided to the user's device in place of the first timer notification. That is, the first timer notification may be cancelled and replaced with a new notification. Alternatively, the system may modify the first timer notification to indicate the newly calculated remaining time and deliver the modified notification to the user at the time of detecting the trigger condition.

In the accessibility context, the system may implement a timer notification mechanism that is compatible with an assistive technology, such as screen readers. Audio notifications are typically interspersed within speech output of a screen reader. In accordance with present embodiments, timer notifications may be combined with audio stream from a screen reader such that the notifications are provided only when user focus changes on the user interface. In particular, a scheduled timer notification may be interrupted (i.e., delayed) until a change in UI focus is detected. When such change is detected, the audio stream may be updated to include the timer notification (e.g., a reminder notification) and the updated audio stream can be provided to the user's screen reader device.

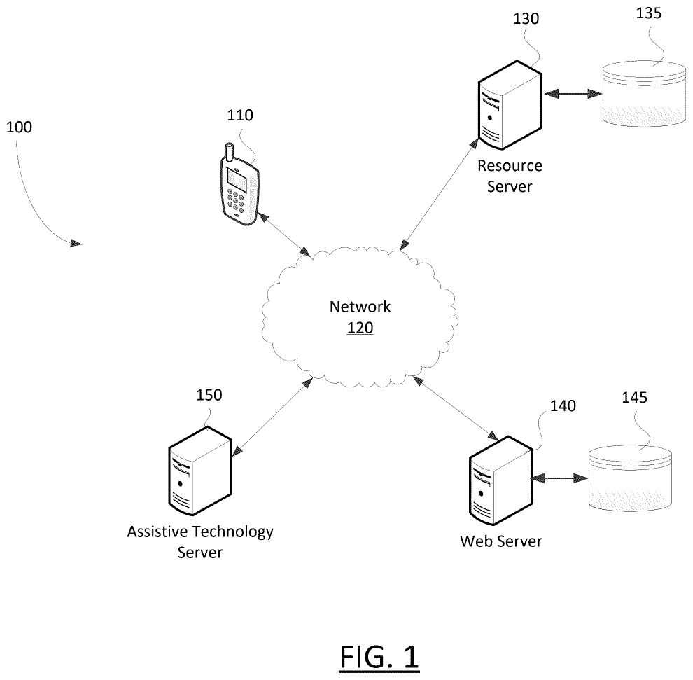

Reference is first made to FIG. 1 which illustrates an exemplary networked environment 100 consistent with certain disclosed embodiments. As shown in FIG. 1, the networked environment 100 may include client devices 110, a resource server 130, a web server 140, an assistive technology server 150, and a communications network 120 connecting one or more of the components of networked environment 100.

The resource server 130 (which may also be referred to as a resource management system) and client devices 110 communicate via the network 120. In at least some implementations, the client device 110 is a computing device. The client device 110 may take a variety of forms including, for example, a mobile communication device such as a smartphone, a tablet computer, a wearable computer such as a head-mounted display or smartwatch, a laptop or desktop computer, or a computing device of another type. The client device 110 is associated with a client entity (e.g., an individual, an organization, etc.) having resources that are managed by or using the resource server 130. For example, the resource server 130 may be a financial institution server and the client entity may be a customer of a financial institution operating the financial institution server. The client device 110 may store software instructions that cause the client device to establish communications with the resource server 130.

The resource server 130 may track, manage, and maintain resources, make lending decisions, and/or lend resources for a plurality of clients. The resources may, for example, include computing resources, such as memory or processor cycles. By way of further example, the resources may include stored value, such as fiat currency, which may be represented in one or more databases. For example, as shown in FIG. 1, the resource server 130 may be coupled to a database 135, which may be provided in secure storage. The secure storage may be provided internally within the resource server 130 or externally; the secure storage may, for example, be provided remotely from the resource server 130. In some embodiments, the secure storage may include one or more data centers. The data centers may, for example, store data with bank-grade security.

The resource server 130 may provide both resource transfer processing (e.g., electronic fund transfers) and data holding (e.g., banking) functions. In particular, the resource server 130 may be both a financial institution server and also a payment transaction processing server. The resource server 130 may, in some embodiments, be a proxy server, serving as an intermediary for requests for client devices 110 seeking resources from other servers.

The database 135 may include data records for a plurality of accounts and at least some of the data records may define a quantity of resources associated with an entity. The client device 110 may be a device belonging to an entity that is associated with a resource account having one or more data records in the database 135. The data records may reflect a quantity of stored resources that are associated with the entity. The resources may include owned resources and, in at least some implementations, borrowed resources (e.g., resources available on credit). The quantity of resources that are available to or associated with an entity may be reflected by a balance defined in an associated data record such as, for example, a bank balance.

In at least some implementations, the database 135 may store various types of information in connection with customers of a business entity that administers the resource server 130. For example, the database 135 may store customer profile data and financial account data associated with customers. The customer profile data may include, without limitation, personal information of registered customers, authentication credentials of the customers, account identifying information (e.g., checking account, savings account, revolving credit line, etc.), and information identifying services (e.g., banking services, investment management services, etc.) and/or programs that are offered to the customers by the business entity. The financial account data may include portfolio data relating to portfolios of investments that are held by customers. A customer's portfolio data may include, for example, information identifying actual positions held by the customer in various securities, information identifying a “virtual” portfolio composed of simulated positions held by the customer in various securities, and “watch lists” specifying various securities that are monitored by the customer.

The business entity associated with the resource server 130 may provide services that are accessible to the client entity. For example, the business entity may provide account management services, financial transaction services, and investment management services for the client entity. In at least some implementations, the resource server 130 may be configured to provide a user interface that allows client devices 110 to access services offered by the business entity. By way of example, the resource server 130 may be configured to provide a website or web-based portal which can be accessed via the client devices 110. The website (or portal) may include web content corresponding to various services offered by the business entity, and the resource server 130 may provide the web content for display on the client devices 110. As another example, the resource server 130 may be associated with a software application which may be installed and/or run on the client devices 110. In some embodiments, the resource server 130 may be a backend server associated with software (e.g., a mobile app, web application, software module, etc.) which may be accessed on the client device 110. The software may, for example, be a mobile banking or investment management application. A graphical user interface (GUI) associated with the application may present the content corresponding to the services offered by the business entity on a display of the client device 110. A customer may interact with the business entity and its service offerings via the GUI of the application.

The web server 140 serves documents (and other resources), which may be in the form of webpages, to the client device 110. The web server 140 may, therefore, function as a website, and may process hypertext transfer protocol (HTTP) requests, serving documents and other resources in response to such requests. An HTTP request may, for example, be issued by an application, such as a web browser, operating on the client device 110. The documents that are served by the web server 140 may include documents of various types including text-based documents, multimedia documents, videos, and audio files. For example, the documents may be hypertext markup language (HTML) documents.

In some implementations, the web server 140 may be operated by an entity different from an entity operating the resource server 130. The profile(s) stored at the resource server 130 and their associated data may thus be maintained privately at the resource server 130 and not made accessible (e.g., shared, disclosed, etc.) to the web server 140.

The networked environment 100 also includes an assistive technology server 150. The assistive technology server 150 may implement a backend of software for delivering assistive technology services. By way of example, the assistive technology server 150 may provide the backend of a screen reader app which may be run on client devices 110. When executed on a client device 110, the screen reader app is configured to convert display contents (e.g., text, images, and other content elements) that are rendered on a display of the client device 110 to speech or braille output. The assistive technology server 150 may interact with dedicated application programming interfaces (APIs) for user interface accessibility.

The client device 110, the resource server 130, the web server 140, and the assistive technology server 150 may be in geographically disparate locations. Put differently, the client device 110 may be remote from the resource server 130, the web server 140, and/or the assistive technology server 150. As explained herein, each of the client device 110, the resource server 130, the web server 140, and the assistive technology server 150 is a computing system.

The network 120 is a computer network. In some embodiments, the network 120 may be an internetwork such as may be formed of one or more interconnected computer networks. For example, the network 120 may be or may include an Ethernet network, an asynchronous transfer mode (ATM) network, a wireless network, or the like.

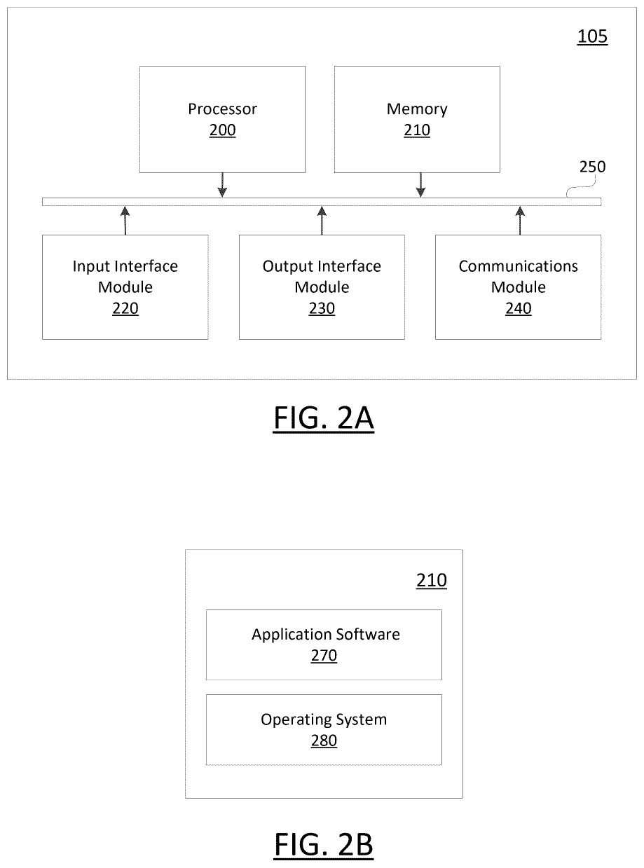

FIG. 2A is a high-level operation diagram of an example computing device 105. In at least some implementations, the example computing device 105 may be exemplary of one or more of the client devices 110, the resource server 130, the web server 140, and the assistive technology server 150. The example computing device 105 includes a variety of modules. For example, the example computing device 105, may include a processor 200, a memory 210, an input interface module 220, an output interface module 230, and a communications module 240. As illustrated, the foregoing example modules of the example computing device 105 are in communication over a bus 250.

The processor 200 is a hardware processor. Processor 200 may, for example, be one or more ARM, Intel x86, PowerPC processors or the like.

The memory 210 allows data to be stored and retrieved. The memory 210 may include, for example, random access memory, read-only memory, and persistent storage. Persistent storage may be, for example, flash memory, a solid-state drive or the like. Read-only memory and persistent storage are a computer-readable medium. A computer-readable medium may be organized using a file system such as may be administered by an operating system governing overall operation of the example computing device 105.

The input interface module 220 allows the example computing device 105 to receive input signals. Input signals may, for example, correspond to input received from a user. The input interface module 220 may serve to interconnect the example computing device 105 with one or more input devices. Input signals may be received from input devices by the input interface module 220. Input devices may, for example, include one or more of a touchscreen input, keyboard, trackball or the like. In some embodiments, all or a portion of the input interface module 220 may be integrated with an input device. For example, the input interface module 220 may be integrated with one of the aforementioned example input devices.

The output interface module 230 allows the example computing device 105 to provide output signals. Some output signals may, for example allow provision of output to a user. The output interface module 230 may serve to interconnect the example computing device 105 with one or more output devices. Output signals may be sent to output devices by output interface module 230. Output devices may include, for example, a display screen such as, for example, a liquid crystal display (LCD), a touchscreen display. Additionally, or alternatively, output devices may include devices other than screens such as, for example, a speaker, indicator lamps (such as for, example, light-emitting diodes (LEDs)), and printers. In some embodiments, all or a portion of the output interface module 230 may be integrated with an output device. For example, the output interface module 230 may be integrated with one of the aforementioned example output devices.

The communications module 240 allows the example computing device 105 to communicate with other electronic devices and/or various communications networks. For example, the communications module 240 may allow the example computing device 105 to send or receive communications signals. Communications signals may be sent or received according to one or more protocols or according to one or more standards. For example, the communications module 240 may allow the example computing device 105 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like.

Additionally, or alternatively, the communications module 240 may allow the example computing device 105 to communicate using near-field communication (NFC), via Wi-Fi™, using Bluetooth™ or via some combination of one or more networks or protocols. Contactless payments may be made using NFC. In some embodiments, all or a portion of the communications module 240 may be integrated into a component of the example computing device 105. For example, the communications module may be integrated into a communications chipset.

Software comprising instructions is executed by the processor 200 from a computer-readable medium. For example, software may be loaded into random-access memory from persistent storage of memory 210. Additionally, or alternatively, instructions may be executed by the processor 200 directly from read-only memory of memory 210.

FIG. 2B depicts a simplified organization of software components stored in memory 210 of the example computing device 105. As illustrated, these software components include application software 270 and an operating system 280.

The application software 270 adapts the example computing device 105, in combination with the operating system 280, to operate as a device performing a particular function. The operating system 280 is software. The operating system 280 allows the application software 270 to access the processor 200, the memory 210, the input interface module 220, the output interface module 230 and the communications module 240. The operating system 280 may be, for example, Apple iOS™, Google Android™, Linux™, Microsoft Windows™, or the like.

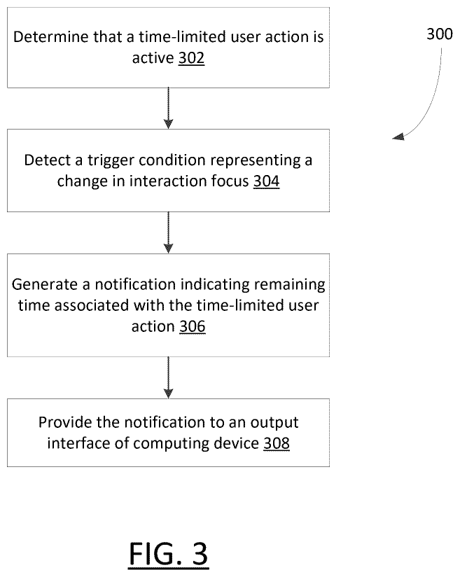

Reference is made to FIG. 3 which shows, in flowchart form, an example method 300 of managing notifications associated with a timer function of a user interface. In at least some embodiments, the method 300 may be implemented as part of a process for providing a user interface for accessing web documents. The operations of method 300 may be performed by a client computing device, either alone or in conjunction with one or more computer server systems. For example, a client computing device that is used for a web browsing session may perform one or more client-side operations of method 300 and one or more servers, such as the resource server 130 and/or assistive technology server 150 of FIG. 1, may perform certain server-side operations of method 300. In some embodiments, a client computing device or a server may perform all of the operations of method 300. In particular, computer-executable instructions stored in memory of a client computing device (or a server computer) may, when executed by a processor of the client computing device (or server), configure the processor to perform the operations of method 300. The instructions corresponding to the operations of method 300 may be executed, for example, as part of software for providing web browsing sessions on the client computing device.

When a document, such as a web or mobile app page, is launched in a user interface of a client computing device, various user actions that are accessible in the document may be displayed. For example, a webpage may contain a plurality of hyperlinks (and more generally, user interface elements) corresponding to user actions that can be accessed on the webpage. A user action may comprise one or more tasks or steps. The user can initiate a user action on the document by selecting the corresponding user interface element.

In operation 302, the processor of the client computing device determines that a time-limited user action is active. That is, the user is determined to be engaged in performing a time-limited action. In particular, the processor detects that a user action has been initiated, and that the user action is one that is associated with certain time-based restrictions. For example, the user action may be a page action for a webpage that is required to be completed within a fixed amount of time (starting from when it is initiated) or during a specific time window between defined start and end times. Examples of user actions on a web or mobile app page include link or button clicks, page visits, form submissions, etc.

In at least some implementations, the processor determines that a user action is active based on the user's interactions with the user interface. A user action may be deemed “active” if the user is determined to be currently interacting with one or more user interface elements associated with the user action. By way of example, a web browser GUI may display a webpage that contains a plurality of user interface elements associated with various page actions. Each page action may be associated with a respective set of user interface elements. In particular, the processor may determine a mapping between user interface elements that are contained in the webpage and one or more defined page actions. The processor monitors, in real-time, the user's interactions with the user interface elements; based on the monitoring, the processor identifies the user action(s) that are active.

The processor is configured to determine the time-based restrictions for the user action and store, in memory, an indication of the time-based restrictions. Further, the processor is configured to track at least one of: the start time of the user action (i.e., the time when the action was first initiated by the user); required end time of the user action; or remaining time for the user action. In at least some implementations, the restrictions define a time limit for completing the user action. That is, the restrictions may indicate a fixed amount of time within which the user action is required to be completed. For example, if a user initiates a time-limited form submission action on a webpage, the processor may determine the amount of time that the user will have to complete the required form fields and to submit the completed form. Additionally, or alternatively, the time-based restrictions may define a time window during which the user action must be performed. A time window may be defined by specifying at least one of a start time, an end time, or a fixed duration of time.

In some implementations, the time-based restrictions for the user action may be determined based on source data or metadata of the document. For example, a webpage may include a timer function, such as a countdown timer UI element, that is tied to a particular user action (e.g., a form submission). The source code and/or metadata for the webpage may indicate the defined restrictions, such as a fixed amount of time or specific time window, associated with the timer function.

In operation 304, the processor detects a trigger condition representing a change, or intended change, in interaction focus. That is, the processor determines that a defined trigger condition relating to the interaction focus is satisfied. An “interaction focus” represents the focus of attention by the user at a particular point in time during their interaction with a user interface. In some implementations, the interaction focus may comprise one or more portions of the user interface. For example, the interaction focus may include at least one UI element, such as a text field, icon, dropdown list, button, etc. that is currently engaged by the user. In particular, the interaction focus may be a UI element that is selected, moved, toggled, or otherwise controlled by the user. The user may interact with the user interface via an input device (e.g., a mouse, keypad, stylus, etc.), touch gesture, voice commands, and the like. The processor may identify the at least one UI element based on detected interactions of the user with the user interface.

Additionally, or alternatively, the interaction focus may be determined based on sensor data obtained from sensors associated with the user's device. For example, the processor may obtain sensor data, such as touch gesture data (e.g., scrolling on a touch-sensitive interface), gaze tracking data, accelerometer and/or gyroscope data, etc., which may be indicative of the user's attention and/or engagement with the user interface. The focus of attention by the user, or the interaction focus, may be determined based on the obtained sensor data.

The processor may identify a specific portion of the user interface as the interaction focus. Alternatively, the interaction focus may be represented as a focus state that is indicative of the user's attention to the user interface. For example, the processor may determine whether the user is currently focused on the user interface (e.g., user's attention is directed to one or more portions of the user interface) or not focused. A change in interaction focus may be determined to be a change in the focus state of the user with respect to the user interface.

The processor may detect one or more trigger conditions based on continuous monitoring of the user's interactions with the user interface and the UI elements contained therein. An example of a trigger condition is a change in focus from one UI element (e.g., a text field) to a different UI element (e.g., another text field, or different UI type such as a button). For example, the trigger condition may comprise movement of a cursor from one text field to a next text field. When the user intentionally changes the focus away from an input field, it may be an indication that the user has completed input for that field and that they are shifting their attention to another UI element.

Another example of a trigger condition is selection or de-selection of an item in an input control UI element (e.g., checkboxes, radio buttons, dropdown lists, list boxes, buttons, toggles, etc.). The selection/de-selection may represent completion of the user's input for the control UI element. In some implementations, the processor may detect the trigger condition only if no subsequent changes to the user's selection or de-selection are detected. For example, if no changes to an item selection are detected within a threshold length of time, the processor may determine that the user input (for the control UI element) is complete and the trigger condition is detected.

Another example of a trigger condition is user navigation (via touch gesture, mouse scroll, navigation keys on keypad, etc.) for moving past an UI element in the user interface. For example, the user may provide navigation input that results in a UI element representing the current interaction focus moving past a defined vertical/horizontal position or out of view of the displayed web/app page. Such navigation input may signal the user's intention to shift their attention to a different portion/element of the user interface.

Another example of a trigger condition is utterance by the user of one or more words in a defined set of terms. The defined terms may include words (e.g., “next”, “done”, etc.) that suggest completion of a current task/step or intention to switch the focus away from a currently selected portion or element of the user interface. The processor may be configured to obtain audio data corresponding to utterances by the user and detect that at least one of the words in the defined set is represented in the audio data.

Another example of a trigger condition is a pause in user interactions (e.g., text input, navigation, etc.) that exceeds a threshold length of time. A pause refers to a period of time during which no user interaction with the user interface is detected. In particular, a pause may be a period of time that immediately follows a stop (or temporary stop) in a user's interaction. The processor measures the duration of a pause starting from the time when the interaction is (temporarily) stopped. Said duration can be compared to a defined threshold length of time for determining whether the trigger condition is satisfied. A pause following user input or other interaction with a UI element may signal that the user has finished a task or step associated with said UI element.

In some implementations, the processor may determine that a trigger condition is satisfied only if a combination of two or more of the above-identified examples of triggers is detected. For example, a trigger condition may be detected only if a user's interaction with a UI element (e.g., selection/de-selection, movement of a cursor, etc.) is immediately followed by a pause that exceeds a defined length of time. The examples of trigger conditions described above signal a shift of the interaction focus during the user's performance of the time-limited user action. A shift of interaction focus may suggest that the user has completed a particular task. This “break” in action-between the previous task and the next task-is likely to be a suitable time for providing related notifications to the user so as to minimize the potential for distracting or interrupting the user. This, in turn, may maximize the effectiveness of such notification(s).

In operation 306, the processor generates a notification indicating the remaining time associated with the time-limited user action. More particularly, a new notification that indicates the remaining time for the user to complete the user action is generated. The processor calculates the remaining time based on the time-based restriction (e.g., a time limit) for the user action, the time of detecting the trigger condition, and the start time of the user action. The notification may be a visual notification or an auditory notification. By way of example, the notification may be in the form of a UI element that contains an indication of the remaining time for the user action. The UI element may be presented directly on the user interface, for example, as a pop-up or other form of visual emphasis that is displayed at a defined position within the document. The visual notification may be designed to be displayed only temporarily. In particular, the visual notification is not a persistent notification; the visual notification may only be displayed for a defined length of time or until the time at which the user's interaction with a different UI element in the user interface is detected.

As another example, the notification may be in the form of a voice notification that indicates the remaining time for the user action. The voice notification may identify the user action, the remaining time, and the currently remaining tasks/steps for completing the user action. The voice notification may be provided by the processor directly or via a suitable application, such as a screen reader app.

The processor provides the generated notification to an output interface associated with a computing device, in operation 308. In particular, the notification is passed to an UI output module of the computing device such that it can be presented—visually, auditorily, or otherwise—to users of the computing device. The computing device, in turn, may pass the notification to an assistive technology process. In some implementations, the notification may be provided to a screen reader app that is resident on the client computing device, or a backend server associated with the application. As mentioned, the notification may comprise an audible reminder of the currently remaining time for the user action. The processor may provide instructions for the notification to be presented in speech output of the screen reader. In particular, the processor may instruct the screen reader app to insert the notification at a suitable point in speech output of the screen reader. For example, the notification may be inserted at a point corresponding to the time when the trigger condition was first detected. As another example, the notification may be inserted after and adjacent to speech output (e.g., verbal description) corresponding to the immediately preceding interaction focus, such as a UI element.

In some implementations, the processor may modify a schedule of notifications for the user action responsive to providing the notification to the output interface. For example, the schedule may be updated to modify scheduled times of one or more subsequent notifications of remaining time for the user action. The subsequent notifications may then be presented, via the computing device, at their respective modified scheduled times.

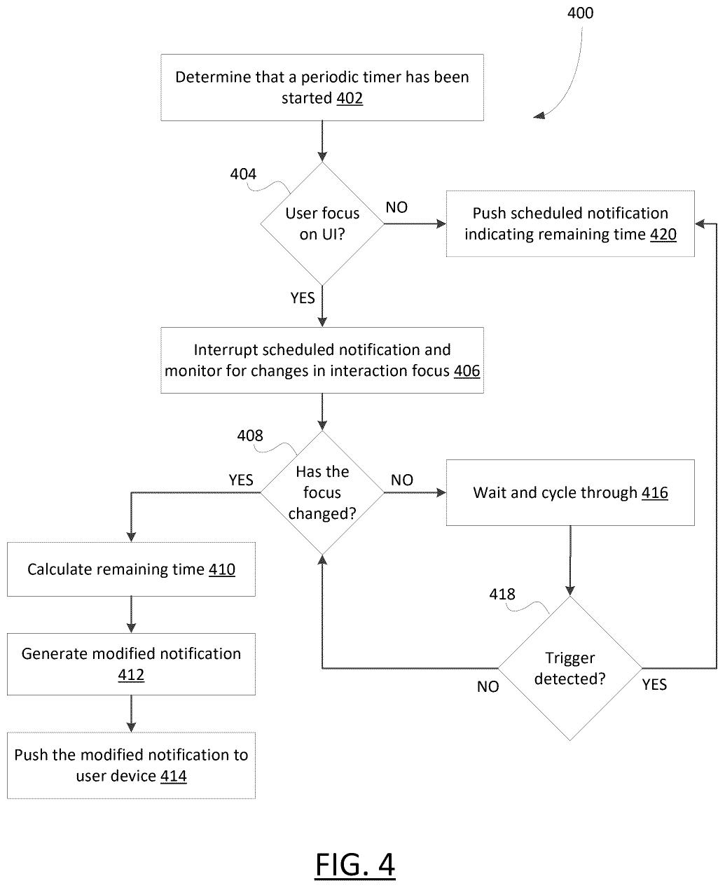

Reference is now made to FIG. 4, which shows, in flowchart form, an example method 400 of managing scheduled notifications associated with a timer function for a user interface. In at least some embodiments, the method 400 may be implemented as part of a process for providing a user interface for accessing web documents. The operations of method 400 may be performed by a client computing device, either alone or in conjunction with one or more computer server systems. The operations of method 400 may be performed in addition to, or as alternatives of, one or more operations of method 300.

A timer function for a user action may enable scheduling reminder notifications that indicate the currently remaining time for a user to complete the action. In particular, where the user action is a time-limited action, reminder notifications can be provided on a user's device in accordance with a defined schedule. The timer function may be launched when the user first initiates the user action. The timer function may, for example, be a periodic timer that is configured to provide reminder notifications at regular intervals as the user performs the user action. In operation 402, the processor determines that a periodic timer has been started. For example, the processor may detect that a user has initiated, via the user interface, a user action and that said user action is a time-limited action. The processor may store, at least, the start time for the user action and any time-based restrictions (e.g., a defined time limit or window) associated with the user action.

At a scheduled time of a first reminder notification, the processor determines whether the user's focus is on the user interface (operation 404). In at least some implementations, the user's focus with respect to the user interface may be indicated by the current interaction focus. As described above, the interaction focus may be determined by monitoring the user's interaction with the user interface. For example, the processor may identify specific portions of the user interface, such as one or more UI elements, which are in focus (e.g., selected) and/or currently engaged by the user (e.g., moved, toggled, etc.) based on detected interactions of the user with the user interface. Additionally, or alternatively, the processor may determine a focus state representing the user's attention to the user interface. For example, the possible focus states for a user may be “in focus” and “not in focus”. The focus state may be determined based on detected interactions or sensor data obtained from various sensors associated with the user's device.

If the user focus is not currently on the user interface, the processor pushes the first reminder notification, as-is, to the client device (operation 420). That is, the processor causes the first reminder notification to be presented in accordance with the original schedule (i.e., at regular intervals) of reminder notifications. The first reminder notification is associated with a predefined amount of remaining time for the user action—this remaining time is presented to the user via the first reminder notification.

If, on the other hand, the user focus is determined to be on the user interface, the processor interrupts the first reminder notification, in operation 406. In particular, the first reminder notification is explicitly prevented from being presented to the user at the scheduled time of the notification. For example, if the user is determined to be interacting with one or more portions (e.g., an UI element) of the user interface at the scheduled time of the first reminder notification, the notification is interrupted (i.e., delayed or canceled). The processor then monitors the user's interactions with the user interface and listens for a change in interaction focus.

In operation 408, the processor detects that the user focus has changed. In some implementations, the processor determines the interaction focus and monitors for trigger conditions representing change(s) in the interaction focus. More particularly, the interaction focus may be taken as a proxy representation of the current user focus with respect to the user interface. A change in interaction focus may be determined in a similar manner as described above with reference to method 300. In particular, the processor may detect a trigger condition representing a change in interaction focus if one or more of the example triggers are determined to be satisfied.

In response to determining that the user focus has changed, the processor calculates the remaining time, in operation 410. The remaining time is calculated relative to the time of detecting the change in user focus. In particular, the remaining time may be determined based on the start time of the user action and time-based restriction(s) associated with said action. Alternatively, in some implementations, the processor may continuously track the remaining time for the timer function once the user initiates the time-limited action. For example, the timer function may be run in the background, without being displayed on the user interface. The processor may then simply query the timer function and determine the amount of the currently remaining time, rather than independently calculating it.

In operation 412, the processor generates a modified notification. That is, the first reminder notification, which was interrupted (e.g., pending but delayed), is modified to indicate the currently remaining time, rather than the predefined amount of the remaining time for the first notification. For example, the modified notification may include updated text/speech indicating the currently remaining time for completing the user action. Alternatively, in some implementations, a new notification may be generated, rather than a modification of the scheduled first notification. The modified (or new) notification including the indication of the currently remaining time for the user action is then caused to be pushed to the user's device, in operation 414.

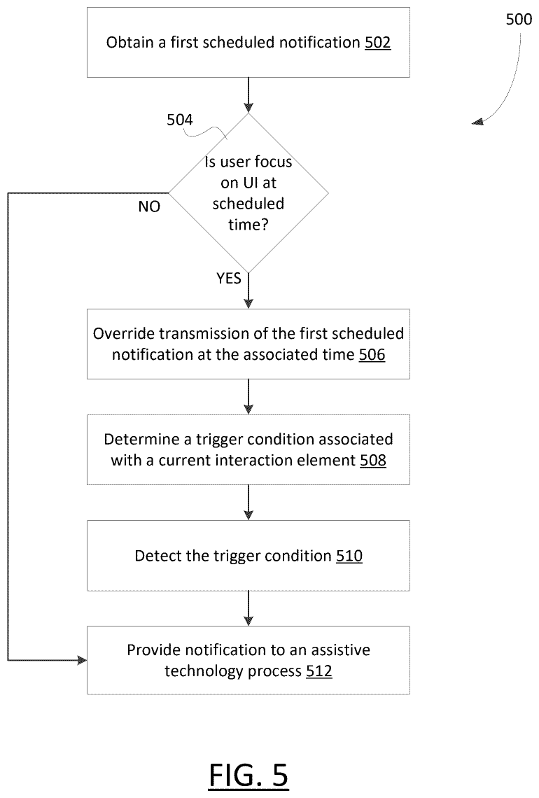

Reference is now made to FIG. 5, which shows, in flowchart form, an example method 500 of providing timer function notifications via an assistive technology process. In at least some embodiments, the method 500 may be implemented as part of a process for providing a user interface for accessing web documents. The operations of method 500 may be performed by a client computing device, either alone or in conjunction with one or more computer server systems. The operations of method 500 may be performed in addition to, or as alternatives of, one or more operations of methods 300 and 400.

A timer function may be launched when a user first initiates a time-limited user action via a user interface. The timer function may enable scheduling of reminder notifications which can be presented to the user after the user action has been initiated. In operation 502, the processor obtains a first scheduled reminder notification of the remaining time for the user action. In at least some implementations, the first reminder notification is a notification that is scheduled to be presented via the user interface at a specific time in accordance with a predefined schedule of notifications for the user action. For example, the first reminder notification may be one of a series of reminder notifications that are scheduled to be provided to the user at regular intervals.

In operation 504, the processor determines whether the user focus is on the user interface at the scheduled time of the first reminder notification. In particular, the processor determines if (1) the user is currently engaging with the user interface, or (2) one or more portions of the user interface are in focus (e.g., selected, highlighted, etc.) at the time that the first reminder is originally scheduled to be presented to the user. The user is determined to be engaging with the user interface if the user interacts with one or more UI elements, for example, by providing input, moving, navigating, or otherwise controlling the UI elements.

If the user focus is not on the user interface, the processor provides the first reminder notification to an assistive technology process (operation 512), such as a screen reader app. The first reminder notification can thus be presented as-is, indicating the predefined amount of remaining time for the first reminder notification.

On the other hand, if the user focus is on the UI at the scheduled time of the first reminder notification, the processor overrides the transmission of the first scheduled reminder notification at the associated time (operation 506). In particular, the first reminder notification is prevented from being transmitted to an assistive technology process or other notification service associated with the user's device. Instead of presenting the first reminder notification, the processor monitors the user's interactions with the user interface and listens for one or more defined triggers.

The processor determines a trigger condition associated with a current interaction element of the user interface, in operation 508. The current interaction element is a component of the user interface with which the user is determined to interact at the scheduled time of the first reminder notification. In at least some implementations, the trigger condition is a condition that represents completion of the user's interaction with a specific UI element. The trigger condition depends on the type of the UI element. For example, an input control component such as a checkbox, radio button, dropdown list, etc., may require an item to be selected for the interaction with the input control to be completed. As another example, a navigational component such as a slider, icons, etc. may require a user input for selecting a navigation value (e.g., select a hyperlinked icon, select a value along a track bar of a slider, etc.).

In operation 510, the processor detects the trigger condition associated with the current interaction element. In response to detecting the trigger condition, the processor provides a notification to an assistive technology process, in operation 512. This notification is a reminder notification that includes the remaining time for the user action as calculated at the time of detecting the trigger condition for the current interaction element. The notification may be a modified version of the first reminder notification (i.e., the indication of remaining time is changed) or it may be a newly generated notification.

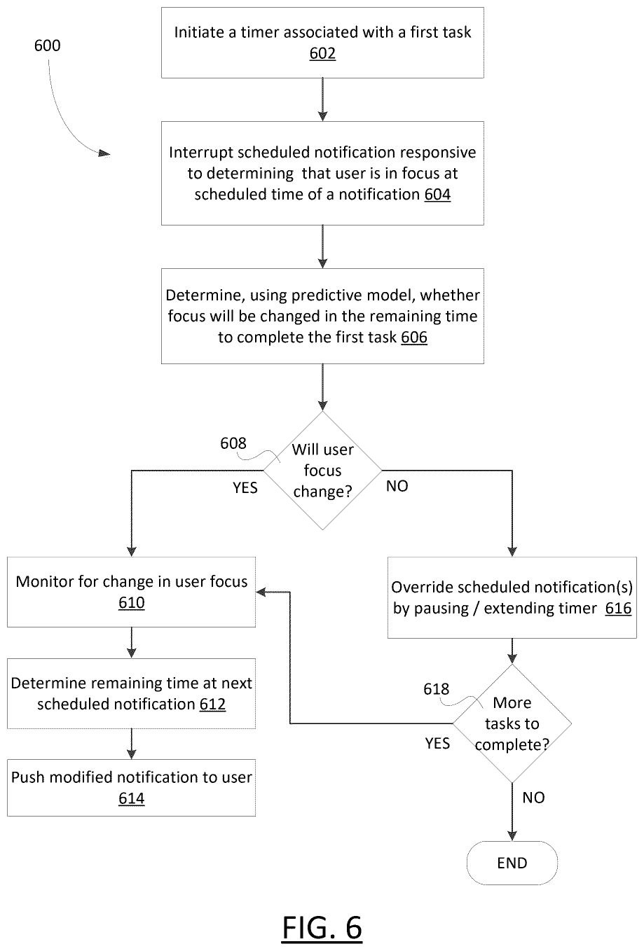

Reference is now made to FIG. 6, which shows, in flowchart form, an example method 600 of managing notifications associated with a timer function for a user interface using a predictive model for analyzing patterns in interaction focus. In at least some embodiments, the method 600 may be implemented as part of a process for providing a user interface for accessing web documents. The operations of method 600 may be performed by a client computing device, either alone or in conjunction with one or more computer server systems. The operations of method 600 may be performed in addition to, or as alternatives of, one or more operations of methods 300 to 500.

In operation 602, the processor initiates a timer associated with a first task. The timer is configured to track the remaining time for a user to complete the first task. In particular, the timer may provide reminder notifications indicating the currently remaining time. The reminder notifications may be scheduled to be presented to the user in accordance with a defined schedule.

At a scheduled time of a reminder notification, the processor may determine that the user focus is on the user interface. The processor may then cause the reminder notification to be interrupted, for example, by delaying or cancelling it (operation 604).

In operation 606, the processor determines, using a predictive model, whether user focus will be changed in the remaining time to complete the first task. A predictive model may comprise a statistical model that is based on historical interaction data of one or more users. The historical interaction data may include statistics relating to past user interactions with a plurality of different UI elements of the user interface. The statistical model may, for example, indicate a distribution of average interaction (e.g., text input, item selections, etc.) or completion times for a type of UI element over a certain population of users.

The processor then determines whether the user focus will change based on the predictive model, in operation 608. If the user focus will change, the processor monitors for change in user focus (operation 610) and provides a modified notification that includes a newly calculated remaining time for the first task (operations 612 and 614). On the other hand, the processor determines that the interaction focus will not change prior to expiry of a time limit associated with the task. In response to determining that the interaction focus will not change, the processor may force an interrupt of the timer for the first task. More specifically, the processor overrides a scheduled reminder notification for the first task (operation 616). In some implementations, the processor may further be configured to, in response to determining that the interaction focus will not change, pause a count by the timer or add additional time to the timer for the first task.

The various embodiments presented above are merely examples and are in no way meant to limit the scope of this application. Variations of the innovations described herein will be apparent to persons of ordinary skill in the art, such variations being within the intended scope of the present application. In particular, features from one or more of the above-described example embodiments may be selected to create alternative example embodiments including a sub-combination of features which may not be explicitly described above.

In addition, features from one or more of the above-described example embodiments may be selected and combined to create alternative example embodiments including a combination of features which may not be explicitly described above. Features suitable for such combinations and sub-combinations would be readily apparent to persons skilled in the art upon review of the present application as a whole. The subject matter described herein and in the recited claims intends to cover and embrace all suitable changes in technology.

1. A computing system, comprising:
a processor; and
a memory coupled to the processor, the memory storing computer-executable instructions that, when executed by the processor, configure the processor to:
determine that a time-limited action is active;
detect a trigger condition representing a change in interaction focus;
in response to detecting the trigger condition:
generate a notification indicating remaining time associated with the time-limited action;
provide the notification to an output interface associated with a computing device.

2. The computing system of claim 1, wherein determining that the time-limited action is active comprises determining that a user is currently interacting with a user interface and wherein the trigger condition is detected based on interactions with the user interface.

3. The computing system of claim 2, wherein detecting the trigger condition comprises determining that the user has:
moved a cursor from one text field to another text field;
selected or de-selected a checkbox;
selected an item from a drop-down menu;
scrolled past a user interface (UI) element such that the UI element moves out of view; or
paused for greater than a threshold length of time.

4. The computing system of claim 1, wherein the instructions, when executed, further configure the processor to obtain a first scheduled notification of the remaining time associated with the time-limited action, wherein generating the notification comprises modifying the first scheduled notification to indicate the remaining time at a time of detecting the trigger condition.

5. The computing system of claim 4, wherein the first scheduled notification is a notification that is scheduled to be presented via a user interface at regular intervals starting from a time when the user first initiated the time-limited action.

6. The computing system of claim 1, wherein the instructions, when executed, further configure the processor to determine that a predetermined amount of time has elapsed since start of the time-limited action and wherein the notification is generated in response to determining that the predetermined amount of time has elapsed and detecting the trigger condition.

7. The computing system of claim 1, wherein the notification comprises an audible reminder of the remaining time and wherein providing the notification comprises inserting the notification in speech output of a screen reader program at a point corresponding to a time of detecting the trigger condition.

8. The computing system of claim 1, wherein the instructions, when executed, further configure the processor to:
determine, based on a predictive model, that the interaction focus will not change prior to expiry of a time limit associated with the time-limited action; and
in response to determining that the interaction focus will not change, force an interrupt of a timer for the time-limited action.

9. The computing system of claim 8, wherein the instructions, when executed, further configure the processor to, in response to determining that the interaction focus will not change, pause a count by the timer or add additional time to the timer.

10. The computing system of claim 1, wherein the instructions, when executed, further configure the processor to modify a schedule of notifications for the time-limited action responsive to providing the notification to the output interface.

11. A computer-implemented method, comprising:
determining that a time-limited action is active;
detecting a trigger condition representing a change in interaction focus;
in response to detecting the trigger condition:
generating a notification indicating remaining time associated with the time-limited action;
providing the notification to an output interface associated with a computing device.

12. The method of claim 11, wherein determining that the time-limited action is active comprises determining that a user is currently interacting with a user interface and wherein the trigger condition is detected based on interactions with the user interface.

13. The method of claim 12, wherein detecting the trigger condition comprises determining that the user has:
moved a cursor from one text field to another text field;
selected or de-selected a checkbox;
selected an item from a drop-down menu;
scrolled past a user interface (UI) element such that the UI element moves out of view; or
paused for greater than a threshold length of time.

14. The method of claim 11, further comprising obtaining a first scheduled notification of remaining time associated with the time-limited action, wherein generating the notification comprises modifying the first scheduled notification to indicate the remaining time at a time of detecting the trigger condition.

15. The method of claim 14, wherein the first scheduled notification is a notification that is scheduled to be presented via the user interface at regular intervals starting from a time when the user first initiated the time-limited action.

16. The method of claim 11, further comprising determining that a predetermined amount of time has elapsed since start of the time-limited action and wherein the notification is generated in response to determining that the predetermined amount of time has elapsed and detecting the trigger condition.

17. The method of claim 11, wherein the notification comprises an audible reminder of the remaining time and wherein providing the notification comprises inserting the notification in speech output of a screen reader program at a point corresponding to a time of detecting the trigger condition.

18. The method of claim 11, further comprising:
determining, based on a predictive model, that the interaction focus will not change prior to expiry of a time limit associated with the time-limited action; and
in response to determining that the interaction focus will not change, forcing an interrupt of a timer for the time-limited action.

19. The method of claim 11, further comprising, in response to determining that the interaction focus will not change, pausing a count by the timer or add additional time to the timer.

20. The method of claim 11, further comprising modifying a schedule of notifications for the time-limited action responsive to providing the notification to the output interface.
